(19) United States
(12) Patent Application Publication
(10) Pub. No.: US 2021/0250278 A1
(43) Pub. Date: Aug. 12, 2021

(54) EFFICIENT FLOW DISTRIBUTION ACROSS LINK-AGGREGATION GROUP MEMBERS

(71) Applicant: ARRIS Enterprises LLC, Suwanee, GA (US)

(72) Inventors: Virendra Malaviya, Cupertino, CA (US); Rishi Mehta, San Jose, CA (US)

(73) Assignee: ARRIS Enterprises LLC, Suwanee, GA (US)

(21) Appl. No.: 17/170,247

(22) Filed: Feb. 8, 2021

Related U.S. Application Data
(60) Provisional application No. 62/972,601, filed on Feb. 10, 2020.

(51) Int. Cl. H04L 12/709; H04L 12/721

(52) U.S. Cl. CPC H04L 45/245; H04L 45/70

(57) ABSTRACT

A computer network device includes: a data plane and ports that direct packets or frames in a network based at least in part on destinations of the packets or frames, where the ports are associated with physical links that use communication protocols; and a control plane that performs network functions Moreover, the computer network device may determine one or more first communication performance metrics of a first port in a first physical link in a link aggregation group (LAG) and one or more second communication performance metrics of a second port in a second physical link in the LAG. Then, based at least in part on the determined one or more first communication performance metrics and the determined one or more second communication performance metrics, the computer network device may assign a given packet or a given frame to the first port or the second port in the LAG.

### CROSS REFERENCE TO RELATED APPLICATIONS

This application claims priority under 35 U.S.C. 119(e) to U.S. Provisional Application Ser. No. 62/972,601, entitled “Efficient Flow Distribution Across Link-Aggregation-Group Members,” by Virendra Malaviya and Rishi Mehta, filed on Feb. 10, 2020, the contents of which are herein incorporated by reference.

### BACKGROUND

### Field

The described embodiments relate to techniques for communicating information among electronic devices, including distributing packets or frames in data flows across members of link aggregation groups (LAGs).

### Related Art

Many electronic devices are capable of wirelessly communicating with other electronic devices. For example, these electronic devices can include a networking subsystem that implements a network interface for: a cellular network (UMTS, LTE, etc.), a wireless local area network or WLAN, e.g., a wireless network such as described in the Institute of Electrical and Electronics Engineers (IEEE) 802.11 standard or Bluetooth from the Bluetooth Special Interest Group of Kirkland, Wash.), and/or another type of wireless network.

Wired or wireless networks, such as WLANs, often include switches or routers for directing packets or frames to their destinations. A switch may receive packets or frames in a data flow at an input port, and may selectively couple the packets or frames to one or more output ports using a switching matrix.

However, when there are dynamic data flows or changes in a communication environment, it can be difficult to efficiently steer or route packets or frames through switches or routers. This inefficiency can degrade the communication performance of a switch or a router, and more generally the communication performance of a wired or a wireless network that includes the switch or the router. When this degradation occurs, the end-user throughput is typically inadequate and the quality of their experience is often unacceptable.

### SUMMARY

In a first group of embodiments, a computer network device is described. This computer network device includes: a data plane and ports that direct packets or frames in a network based at least in part on destinations of the packets or frames, where the ports are associated with physical links that use communication protocols; and a control plane that performs network functions. Moreover, the computer network device may determine one or more first communication performance metrics of a first port in a first physical link in a LAG and one or more second communication performance metrics of a second port in a second physical link in the LAG. Then, based at least in part on the determined one or more first communication performance metrics and the determined one or more second communication performance metrics, the computer network device may assign a given packet or a given frame to the first port or the second port in the LAG.

Note that the computer network device may be a switch or a router.

Moreover, the network may include: a wired network, a wireless network or a satellite network.

The computer network device may define at least the first port in the first physical link and the second port in the second physical link as being part of the LAG. Furthermore, the first physical link and the second physical link may use different types of media and/or different communication protocols. For example, the different communication protocols may have different data rates or speeds, different throughputs and/or different capacities. Alternatively, the first physical link and the second physical link may use the same medium and the same communication protocol.

Additionally, the given packet or the given frame may be assigned to the first port or the second port in the LAG based at least in part on a type of traffic of a data flow that includes the given packet or the given frame. In some embodiments, the given packet or the given frame may be assigned to the first port or the second port in the LAG based at least in part on a priority associated with the type of traffic of a data flow.

Note that a given communication performance metric may include utilization or throughput. For example, the utilization of a given physical link may be determined based at least in part on: a number of data flows conveyed by the given link, a number of bytes conveyed, a capacity of the given physical link, a type of traffic, etc.

Moreover, the assignment may provide a more balanced utilization of the first physical link and the second physical link in the LAG than a technique in which the first physical link or the second physical link is randomly or pseudo-randomly selected (such as a hash table).

Furthermore, the assignment may be determined locally by the computer network device and/or remotely (such as by a separate controller). For example, the control plane (such as a processor in the control plane) may implement a controller that performs the network functions for the computer network device, such as determining the assignment. Alternatively or additionally, the computer network device may provide, to a separate controller, information specifying the one or more determined first communication performance metrics and the one or more determined second communication performance metrics. Then, the computer network device may receive, from the separate controller, information specifying the assignment.

In some embodiments, the assignment is based at least in part on capabilities of the first physical link and the second physical link in the LAG.

Note that the assignment may assign different data flows to the first physical link or the second physical link.

Moreover, the first physical link or the second physical link may be a dormant physical link until the assignment of the given packet or the given frame to the dormant physical link.

Another embodiment provides a computer-readable storage medium for use with the computer network device. When executed by the computer network device, this computer-readable storage medium causes the computer network device to perform at least some of the aforementioned operations.

Another embodiment provides a method for load-balancing physical links in a LAG, which may be performed by the computer network device. This method includes at least some of the aforementioned operations.

In a second group of embodiments, a controller is described. This controller may include a network interface that communicates with multiple computer network devices. Moreover, the controller may include a processor. During operation, the controller receives, via the network interface and associated with the computer network devices, communication performance metrics of physical links among the computer network devices. Then, the controller determines an assignment of a data flow to a physical link in multiple physical links in a LAG in at least a first computer network device in the computer network devices based at least in part on the communication performance metrics of the physical links provided by multiple computer network devices. Next, the controller provides, via the network interface, the assignment addressed to the first computer network device.

Note that the computer network devices may include switches and/or routers.

Furthermore, at least some of the physical links may use different types of media and/or different communication protocols. For example, the different communication protocols may have different data rates or speeds, different throughputs and/or different capacities. Alternatively, the physical links may use the same medium and the same communication protocol.

Additionally, the assignment may be based at least in part on a type of traffic of the data flow. In some embodiments, the assignment may be based at least in part on a priority associated with a type of traffic of the data flow.

Note that a given communication performance metric may include utilization or throughput. For example, the utilization of a given physical link may be determined based at least in part on: a number of data flows conveyed by the given link, a number of bytes conveyed, a capacity of the given physical link, a type of traffic, etc.

Moreover, the assignment may provide a more balanced utilization of the physical links in the LAG than a technique in which the first physical link or the second physical link is randomly or pseudo-randomly selected (such as a hash table).

Furthermore, the assignment may be based at least in part on capabilities of the physical links.

Additionally, the assignment may assign different data flows to the physical links.

In some embodiments, at least one of the physical links may be a dormant physical link until the assignment of the data flow to the dormant physical link.

Another embodiment provides a computer-readable storage medium for use with the computer network device. When executed by the computer network device, this computer-readable storage medium causes the computer network device to perform at least some of the aforementioned operations.

Another embodiment provides a method for load-balancing physical links in a LAG, which may be performed by the computer network device. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among access points and electronic devices in a wireless network in accordance with an embodiment of the present disclosure.

FIG. 2 is a flow diagram illustrating an example of a method for load-balancing physical links in a link aggregation group (LAG) using a computer network device in FIG. 1 in accordance with an embodiment of the present disclosure.

FIG. 3 is a drawing illustrating an example of communication among components in a computer network device in FIG. 1 in accordance with an embodiment of the present disclosure.

FIG. 4 is a flow diagram illustrating an example of a method for load-balancing physical links in a LAG using a controller in FIG. 1 in accordance with an embodiment of the present disclosure.

FIG. 5 is a drawing illustrating an example of communication among electronic devices in FIG. 1 in accordance with an embodiment of the present disclosure.

FIG. 6 is a drawing illustrating an example of physical links in a LAG between computer network devices in FIG. 1 in accordance with an embodiment of the present disclosure.

FIG. 7 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, a computer network device (such as a switch or a router, which is sometimes referred to as a ‘node’) is described. The computer network device may include: a data plane and ports that direct packets or frames in a network based at least in part on destinations of the packets or frames, where the ports are associated with physical links that use communication protocols; and a control plane that performs network functions Moreover, the computer network device may determine one or more first communication performance metrics of a first port in a first physical link in a LAG and one or more second communication performance metrics of a second port in a second physical link in the LAG. Then, based at least in part on the determined one or more first communication performance metrics and the determined one or more second communication performance metrics, the computer network device may assign a given packet or a given frame to the first port or the second port in the LAG.

By determining the assignment, this communication technique may load balance the physical links in the LAG. This capability may improve the communication performance of the computer network device and/or a network that includes the computer network device (such as improved throughput, utilization, capacity, and/or more robust communication). Consequently, the communication technique may improve the user experience when using the network.

In a second group of embodiments, a controller is described. The controller may include a network interface that communicates with multiple computer network devices (such as switches and/or routers). Moreover, the controller may include a processor. During operation, the controller may receive, from the computer network devices, communication performance metrics of physical links among the computer network devices. Then, the controller may determine an assignment of a data flow to a physical link in multiple physical links in a link aggregation group (LAG) in at least a first computer network device in the computer network devices based at least in part on the communication performance metrics of the physical links provided by multiple computer network devices. Next, the controller may provide the assignment to the first computer network device.

By determining the assignment, this communication technique may load balance the physical links in the LAG. This capability may improve the communication performance of the first computer network device and/or a network that includes the first computer network device (such as improved throughput, utilization, capacity, and/or more robust communication). Consequently, the communication technique may improve the user experience when using a network that includes the computer network devices.

In the discussion that follows, the computer network device(s) and other electronic devices in the network (such as an access point or recipient electronic devices, which are sometimes referred to as ‘clients’) may communicate packets or frames in accordance with a wireless communication protocol, such as an Institute of Electrical and Electronics Engineers (IEEE) 802.11 standard (which is sometimes referred to as ‘Wi-Fi,’ from the Wi-Fi Alliance of Austin, Texas), Bluetooth (from the Bluetooth Special Interest Group of Kirkland, Washington), and/or another type of wireless interface. In the discussion that follows, Wi-Fi is used as an illustrative example. However, a wide variety of communication protocols (such as Long Term Evolution or LTE, another cellular-telephone communication protocol, a satellite communication protocol, etc.) may be used. The wireless communication may occur in a 2.4 GHz, a 5 GHz and/or a 60 GHz frequency band. (Note that IEEE 802.11ad communication over a 60 GHz frequency band is sometimes referred to as ‘WiGig.’ In the present discussion, these embodiments also encompassed by ‘Wi-Fi.’)

Moreover, the computer network device(s), the controller and/or the access point may communicate with one or more other access points and/or computers in the WLAN using a wireless or a wired communication protocol, such as an IEEE 802.11, an IEEE 802.3 standard (which is sometimes referred to as ‘Ethernet’) and/or another type of wired or wireless interface. In the discussion that follows, Ethernet is used as an illustrative example of communication between the computer network devices and/or the access point and one or more other access points, computers in a WLAN and/or the controller.

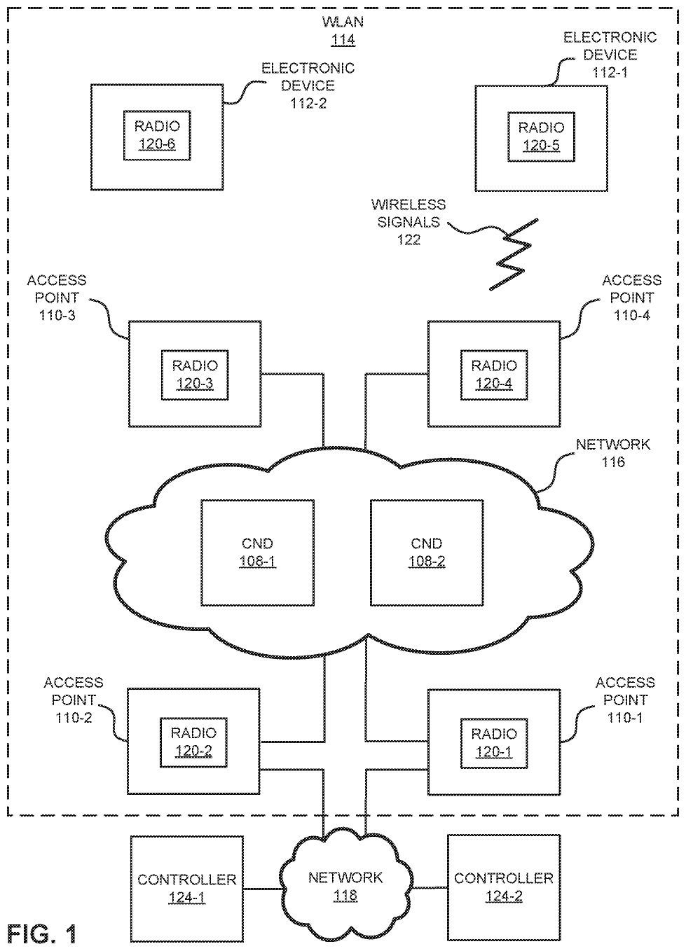

FIG. 1 presents a block diagram illustrating an example of communication among one or more access points 110 and electronic devices 112 (such as a cellular telephone, and which are sometimes referred to as ‘clients’) in a WLAN 114 in accordance with some embodiments. While FIG. 1 is illustrated using WLAN 114, in other embodiments the communication technique may be used with: a wired network, a wireless network and/or a satellite network. In WLAN 114, access points 110 may communicate with each other using wireless and/or wired communication (such as by using Ethernet or a communication protocol that is compatible with Ethernet). Note that access points 110 may include a physical access point and/or a virtual access point that is implemented in software in an environment of an electronic device or a computer. In addition, at least some of access points 110 (such as access points 110-3 and 110-4) may communicate with electronic devices 112 using wireless communication.

The wired and/or wireless communication among access points 110 in WLAN 114 may occur via network 116 (such as an intra-net, a mesh network, point-to-point connections and/or the Internet) and may use a network communication protocol, such as Ethernet. This network may include one or more routers and/or switches. For example, WLAN 114 may include one or more computer network devices (CNDs) 108, such as a switch and/or a router. These computer network devices may include: a data plane and ports that directs packets or frames in a network (such as WLAN 114) based at least in part on destinations of the packets or frames, where the ports are associated with physical links that use communication protocols; and a control plane that performs network functions and that may optionally implement a controller or the functions of a controller. Furthermore, the wireless communication using Wi-Fi may involve: transmitting advertising frames on wireless channels, detecting one another by scanning wireless channels, establishing connections (for example, by transmitting association or attach requests), and/or transmitting and receiving packets (which may include the association requests and/or additional information as payloads). In some embodiments, the wired and/or wireless communication among access points 110 also involves the use of dedicated connections, such as via a peer-to-peer (P2P) communication technique. Therefore, access points 110 may support wired communication within WLAN 114 (such as Ethernet) and wireless communication within WLAN 114 (such as Wi-Fi). Moreover, one or more of access points 110 may also support a wired communication protocol for communicating via network 118 with electronic devices (such as a computer or one of controllers 124 of the one or more computer network devices 108, which may be remoted located from WLAN 114).

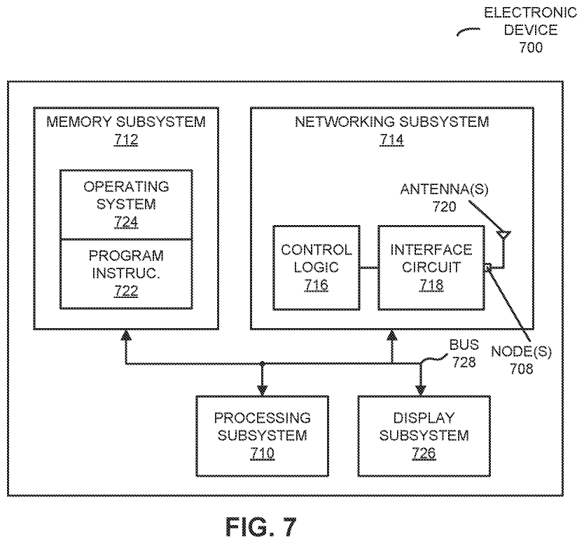

As described further below with reference to FIG. 7, the one or more computer network devices 108, access points 110 and/or electronic devices 112 may include subsystems, such as a networking subsystem, a memory subsystem and a processor subsystem. In addition, access points 110 and electronic devices 112 may include radios 120 in the networking subsystems. More generally, access points 110 and electronic devices 112 can include (or can be included within) any electronic devices with the networking subsystems that enable access points 110 and electronic devices 112 to communicate with each other using wireless and/or wired communication. This wireless communication can comprise transmitting advertisements on wireless channels to enable access points 110 and/or electronic devices 112 to make initial contact or detect each other, followed by exchanging subsequent data/management frames (such as association requests and responses) to establish a connection, configure security options (e.g., Internet Protocol Security), transmit and receive packets or frames via the connection, etc. Note that while instances of radios 120 are shown in access points 110 and electronic devices 112, one or more of these instances may be different from the other instances of radios 120.

As can be seen in FIG. 1, wireless signals 122 (represented by a jagged line) are transmitted from radio 120-4 in access point 110-4. These wireless signals may be received by radio 120-5 in electronic device 112-1. Notably, access point 110-4 may transmit packets or frames. In turn, these packets or frames may be received by electronic device 112-1. Moreover, access point 110-4 may allow electronic device 112-1 to communicate with other electronic devices, computers and/or servers via networks 116 and/or 118.

Note that the communication among the one or more computer network devices 108, access points 110 and/or with electronic devices 112 (and, more generally, communication among components in WLAN 114) may be characterized by a variety of performance metrics, such as: a received signal strength (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate or a ratio of an amount of traffic relative to a peak amount of traffic (either of which is sometimes referred to as ‘utilization’).

In the described embodiments processing a packet or frame in the one or more computer network devices 108, access points 110 and electronic devices 112 includes:

receiving signals (such as wireless signals 122) with the packet or frame; decoding/extracting the packet or frame from the received wireless signals 122 to acquire the packet or frame; and processing the packet or frame to determine information contained in the packet or frame.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As noted previously, it can be difficult to efficiently steer or route packets or frames through switches or routers. For example, physical links in a LAG may be used inefficiently, which can result in degraded communication performance or service, even though the combined physical links in the LAG may, in principle, have sufficient capacity.

These problems may be exacerbated when the physical links in the LAG are heterogeneous, such as when the physical links (and, thus, ports in computer network devices 108) use different types of media and/or different communication protocols. For example, the different communication protocols may have different data rates or speeds, different throughputs and/or different capacities. When different physical links are bundled together in a LAG, the typical approach for assigning data flows to the physical links may result in sub-optimal communication performance. Notably, when a data flow is randomly assigned to a physical link in a LAG (such as a technique in which physical links are randomly or pseudo-randomly selected, such as by using a hash table to determine an assignment of a data flow based on one or more input parameters, e.g., locations of a source or a destination) without considering the capabilities or loading of this physical link, the communication performance may be degraded. Moreover, different types of traffic (such as data, control, or one of the access categories of voice, video, best effort, and background) may have different associated priorities. However, because a technique in which a physical link is randomly or pseudo-randomly selected does not include this information when determining the assignment of a data flow to the physical link in a LAG, service may be degraded, which is frustrating to users.

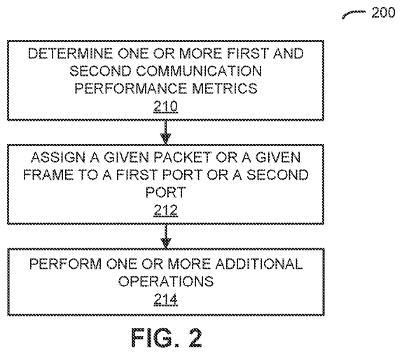

As described further below with reference to FIGS. 2-6, in order to address these problems, a given computer network device (such as computer network device 108-1) may determine one or more first communication performance metrics of a first port in a first physical link in a LAG and one or more second communication performance metrics of a second port in a second physical link in the LAG. (While two physical links in the LAG are used to illustrate the communication technique, in other embodiments there may be more than two physical links in the LAG.) For example, a given communication performance metric may include a throughput or a utilization of a given physical link. For example, the utilization of the given physical link may be determined based at least in part on: a number of data flows conveyed by the given link, a number of bytes conveyed, a capacity of the given physical link, a type of traffic, etc.

Then, based at least in part on the determined one or more first communication performance metrics and the determined one or more second communication performance metrics, computer network device 108-1 may assign a given packet or a given frame to the first port in the physical link or the second port in the second physical link in the LAG. More generally, computer network device 108-1 may assign a data flow, which includes the given packet or the given frame, to the first port in the physical link or the second port in the second physical link.

Moreover, the given packet or the given frame may be assigned to the first port or the second port in the LAG based at least in part on a type of traffic of a data flow that includes the given packet or the given frame. Furthermore, the given packet or the given frame may be assigned to the first port or the second port in the LAG based at least in part on a priority associated with the type of traffic of the data flow. Additionally, the assignment may be based at least in part on capabilities of the first physical link and the second physical link in the LAG.

Furthermore, computer network device 108-1 may define at least the first port in the first physical link and the second port in the second physical link as being part of the LAG. Note that the first physical link and the second physical link may use different types of media and/or different communication protocols. For example, the different communication protocols may have different data rates or speeds, different throughputs and/or different capacities. Alternatively, the first physical link and the second physical link may use the same medium and the same communication protocol.

Note that the assignment may assign different data flows to the first physical link or the second physical link. Moreover, the assignment may provide a more balanced utilization of the first physical link and the second physical link in the LAG than a technique in which the first physical link or the second physical link is randomly or pseudo-randomly selected (such as a hash table). In some embodiments, the first physical link or the second physical link may be a dormant physical link until the assignment of the given packet or the given frame to the dormant physical link.

In some embodiments, the assignment may be determined locally by computer network device 108-1, such as by a processor in a control plane thereof. However, in other embodiments, the assignment may, at least in part, be determined remotely by a separate controller (such as controller 124-1). For example, computer network device 108-1 may provide, to controller 124-1, information specifying the one or more determined first communication performance metrics and the one or more determined second communication performance metrics. In response, controller 124-1 may determine the assignment. For example, a processor in controller 124-1 may determine an assignment of a data flow to a physical link in the LAG (such as the first physical link or the second physical link). Then, controller 124-1 may provide, to computer network device 108-1, information specifying the assignment. In some embodiments, controller 124-1 may determine the assignment for at least computer network device 108-1 based at least in part on communication performance metrics that are received from multiple computer network devices 108.

While the preceding discussion illustrated the determination of the assignment locally (by computer network device 108-1) or remotely (by controller 124-1), in other embodiments the network functions may be modular, so that they can be performed in a distributed manner. For example, the assignment may be determined by multiple controllers 124 or jointly by computer network device 108-1 and controller 124-1. In some embodiments, computer network devices may provide or share the determined communication performance metrics with each other, so that a given computer network device (such as computer network device 108-1) can determine the assignment based at least in part on the determined communication performance metrics from multiple computer network devices 108.

In this way, the communication technique may allow packets, frames and/or data flows to be assigned to the physical links in the LAG with situational awareness, such as based at least in part on communication performance metrics of the physical links, capabilities of the physical links and/or priorities of types of traffic in the data flows. Consequently, the communication technique may allow improved use of the physical links in the LAG, with a commensurate impact on the communication performance and service, which may increase customer satisfaction and retention.

We now describe embodiments of a method. FIG. 2 presents a flow diagram illustrating an example of a method 200 for load balancing physical links in a LAG using a computer network device, such as computer network device 108-1 in FIG. 1.

During operation, the computer network device may determine one or more first communication performance metrics (operation 210) of a first port in a first physical link in a LAG and one or more second communication performance metrics (operation 210) of a second port in a second physical link in the LAG. Note that the computer network device may be a switch or a router. Moreover, the first physical link and the second physical link may use different types of media and/or different communication protocols. For example, the different communication protocols may have different data rates or speeds, different throughputs and/or different capacities. Alternatively, the first physical link and the second physical link may use the same medium and the same communication protocol.

In some embodiments, a given communication performance metric may include utilization or throughput. For example, the utilization of a given physical link may be determined based at least in part on: a number of data flows conveyed by the given link, a number of bytes conveyed, a capacity of the given physical link, a type of traffic, etc.

Then, based at least in part on the determined one or more first communication performance metrics and the determined one or more second communication performance metrics, the computer network device may assign a given packet or a given frame to the first port or the second port (operation 212) in the LAG.

In some embodiments, the computer network device may optionally perform one or more additional operations (operation 214). For example, the computer network device may define at least the first port in the first physical link and the second port in the second physical link as being part of the LAG.

Moreover, the given packet or the given frame may be assigned to the first port or the second port in the LAG based at least in part on a type of traffic of a data flow that includes the given packet or the given frame. Furthermore, the given packet or the given frame may be assigned to the first port or the second port in the LAG based at least in part on a priority associated with the type of traffic of a data flow. In some embodiments, the assignment is based at least in part on capabilities of the first physical link and the second physical link in the LAG.

Furthermore, the assignment may be determined locally by the computer network device and/or remotely (such as by a separate controller). For example, the computer network device may include a control plane (such as a processor in the control plane) that implements a controller that determines the assignment. Alternatively or additionally, the computer network device may provide, to a separate controller, information specifying the one or more determined first communication performance metrics and the one or more determined second communication performance metrics. Then, the computer network device may receive, from the separate controller, information specifying the assignment.

Note that the assignment may assign different data flows to the first physical link or the second physical link. Moreover, the first physical link or the second physical link may be a dormant physical link until the assignment of the given packet or the given frame to the dormant physical link.

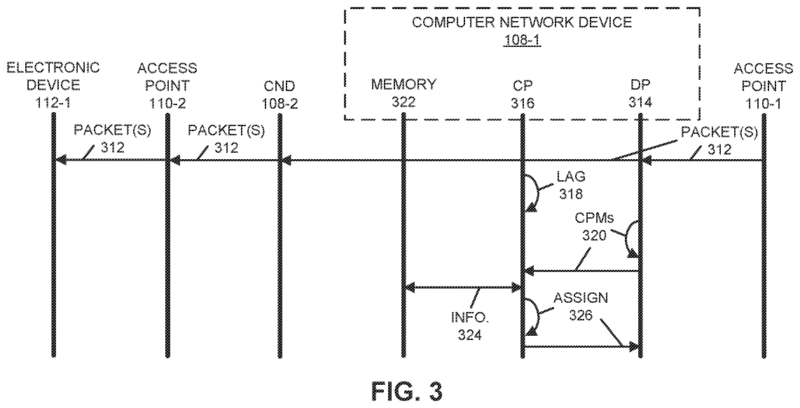

FIG. 3 presents a drawing illustrating an example of communication among components in computer network device 108-1, computer network device 108-2, access point 110-1 and electronic device 112-1. Notably, access point 110-1 may communicate packets 312 or frames with computer network device 108-1.

Packets 312 may be received by a data plane (DP) 314 in computer network device 108-1. Note that data plane 314 may direct packets 312 to their destination (e.g., electronic device 112-1 via access point 110-2). For example, data plane 314 may include ports in physical links between computer network device 108-1 and computer network device 108-2, and packets 312 may be communicated via one or more of physical links to computer network device 108-2 and then to electronic device 112-1.

Moreover, computer network device 108-1 may include a control plane (CP) 316 (with one or more processors that implement a controller) that performs network functions and manages data plane 314. Control plane 316 may define a LAG 318 with at least two of the physical links. For example, LAG 318 may include a first physical link and a second physical link. Note that a first port in computer network device 108-1 may be included in the first physical link, and a second port in computer network device 108-1 may be included in the second physical link.

Furthermore, during communication of packets 312, data plane 314 may determine or monitor one or more communication performance metrics (CPMs) 320 (such as utilization, throughput, queue depth, etc.) of (or associated with) the ports in the physical links in LAG 318, which may be communicated to control plane 316. Then, control plane 316 may optionally access information 324 about the physical links in LAG 318 in memory 322 in computer network device 108-1, such as capabilities of the physical links in LAG 318.

Next, control plane 316 may selectively assign 326 a given packet in packets 312 (and, more generally, a data flow) to a given physical link in LAG 318 based at least in part on the one or more communication performance metrics 320, a type of traffic, a priority of the type of traffic, and/or the capabilities of the physical links in LAG 318. This assignment may be communicated from control plane 316 to data plane 314.

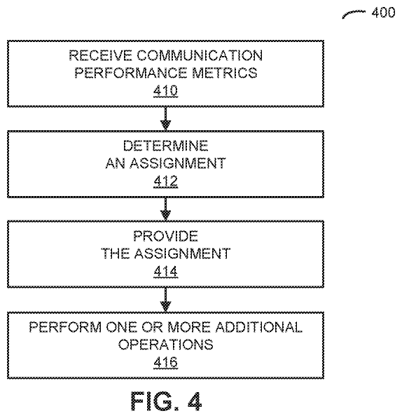

We now describe embodiments of a method. FIG. 4 presents a flow diagram illustrating an example of a method 400 for load balancing physical links in a LAG using a controller, such as controller 124-1 in FIG. 1.

During operation, the controller may receive, from computer network devices, communication performance metrics (operation 410) of physical links among the computer network devices. Note that the computer network devices may include switches and/or routers. Moreover, at least some of the physical links may use different types of media and/or different communication protocols. For example, the different communication protocols may have different data rates or speeds, different throughputs and/or different capacities. Alternatively, the physical links may use the same medium and the same communication protocol.

Note that a given communication performance metric may include utilization or throughput. For example, the utilization of a given physical link may be determined based at least in part on: a number of data flows conveyed by the given link, a number of bytes conveyed, a capacity of the given physical link, a type of traffic, etc.

Then, the controller may determine an assignment of a data flow (operation 412) to a physical link in multiple physical links in a LAG in at least a first computer network device in the computer network devices based at least in part on the communication performance metrics of the physical links provided by multiple computer network devices.

Next, the controller may provide the assignment (operation 414) to the first computer network device.

In some embodiments, the controller may optionally perform one or more additional operations (operation 416). For example, the assignment may be based at least in part on a type of traffic of the data flow. Moreover, the assignment may be based at least in part on a priority associated with a type of traffic of the data flow. Furthermore, the assignment may be based at least in part on capabilities of the physical links.

Note that the assignment may assign different data flows to the physical links. Moreover, at least one of the physical links may be a dormant physical link until the assignment of the data flow to the dormant physical link.

In some embodiments of method 200 (FIG. 2) and/or 400, there may be additional or fewer operations. Moreover, there may be different operations. Furthermore, the order of the operations may be changed, and/or two or more operations may be combined into a single operation.

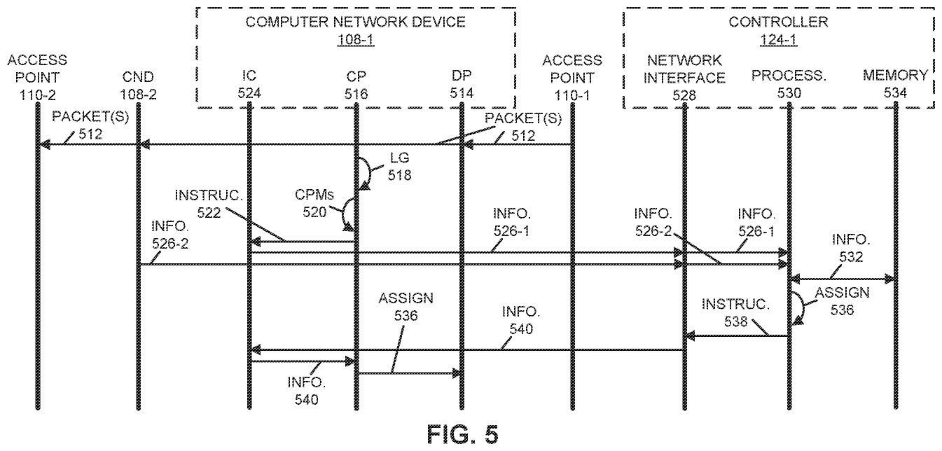

FIG. 5 presents a drawing illustrating an example of communication among computer network devices 108, access point 110-1, electronic device 112-1, and controller 124-1. Notably, access point 110-1 may communicate packets 512 or frames with computer network devices 108.

In a given computer network device (such as computer network device 108-1), packets 512 may be received by a data plane (DP) 514 in computer network device 108-1. Note that data plane 514 may direct packets 512 to their destination (e.g., electronic device 112-1 via access point 110-2). For example, data plane 514 may include ports in physical links between computer network device 108-1 and computer network device 108-2, and packets 512 may be communicated via one or more of physical links to computer network device 108-2 and then to electronic device 112-1.

Moreover, computer network device 108-1 may include a control plane 516 (with one or more processors) that performs network functions and manages data plane 514. Control plane 516 may define a LAG 518 with at least two of the physical links. For example, LAG 518 may include a first physical link and a second physical link. Note that a first port in computer network device 108-1 may be included in the first physical link, and a second port in computer network device 108-1 may be included in the second physical link.

Furthermore, during communication of packets 512, data plane 514 may determine or monitor an instance of one or more communication performance metrics 520 (such as utilization, throughput, queue depth, etc.) of or associated with the ports in the physical links in LAG 518. Then, control plane 516 may instruct 522 interface circuit 524 in computer network device 108-1 to provide information 526-1 specifying the instance of the one or more communication performance metrics 520 to controller 124-1. The other computer network devices (such as computer network device 108-2) may determine or monitor the one or more communication performance metrics and may provide information specifying instances of the one or more communication performance metrics to controller 124-1. For example, computer network device 108-2 may provide information 526-2 to controller 124-1.

After network interface 528 in controller 124-1 receives information 526, it may be provided to processor 530 in controller 124-1. Processor 530 may optionally access information 532 about the physical links in LAG 518 in memory 534 in controller 124-1, such as capabilities of the physical links in LAG 518.

Next, processor 530 may selectively assign 536 a data flow to a given physical link in LAG 518 based at least in part on the one or more communication performance metrics 520, a type of traffic, a priority of the type of traffic, and/or the capabilities of the physical links in LAG 518. Moreover, processor 530 may instruct 538 network interface 528 to provide information 540 specifying assignment 536 to at least computer network device 108-1.

After receiving information 540, interface circuit 524 may provide information 540 to control plane 516, which may provide assignment 536 to data plane 514.

While FIGS. 3 and 5 illustrates communication between components using unidirectional or bidirectional communication with lines having single arrows or double arrows, in general the communication in a given operation in these figures may involve unidirectional or bidirectional communication.

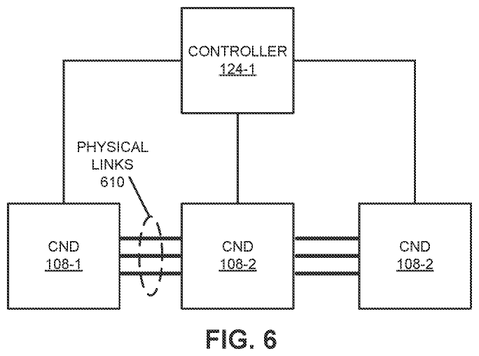

FIG. 6 presents a drawing illustrating an example of physical links 610 in a LAG between computer network devices 108 in FIG. 1. Computer network devices 108 may determine (periodically, as needed, after a time interval has elapsed, etc.) communication performance metrics of physical links 610 and/or a number of data flows on each of physical links 610. Then, computer network devices 108 may determine assignments of data flows to physical links 610 based at least in part on the determined information. Alternatively or additionally, computer network devices 108 may provide the determined information to controller 124-1, which may determine the assignments and then provide the determined assignments to computer network devices 108. Using the assignments, computer network devices 108 may steer the traffic (such as the data flows) to one or more of physical links 610.

In some embodiments, physical links 610 may operate at same speed and may use the same medium. For example, a LAG defined according to the Institute of Electrical and Electronics Engineers (IEEE) 802.1ax-2008 standard may include ports that have the same speed or data rate. Alternatively, physical links 610 may have different capacities, different speeds or data rates, and/or may use different types of media. In some embodiments, physical links 610 may include: a mono-mode optical fiber, a multi-mode optical fiber and/or copper wire.

When the assignments activate a dormant physical link, at least one of computer network devices 108 may notify another of computer network devices 108 that it is activating the dormant physical link to increase capacity. For example, computer network device 108-1 on one end of the dormant physical link may notify computer network device 108-2 on the other end of the dormant physical link using a LAG update message.

In some embodiments, the physical links in a LAG may operate at the same speed and the underlying physical medium type may be the same (e.g., copper wire or optical fiber). Periodically (such as every 50 ms, 100 ms, 1 s, 10 s, 30 s, 1 min, 3, min, 10 min, etc.), computer network devices in the physical links may determine utilization (and, more generally, one or more communication performance metrics) of each of the physical links in the LAG. Note that the utilization may be determined based at least in part on: a number flows each physical link is carrying, a number of bytes, whether a physical link is operating at full capacity, type of traffic, etc.

Using the one or more determined communication performance metrics, a given computer network device may assign a set of one or more data flows to the physical links in the LAG. For example, a data flow may be assigned to an underutilized physical link.

The assignment may be performed in a controller, which may be implemented locally (e.g., in a given computer network device) and/or remotely (e.g., in a cloud-based controller). For example, the given computer network device may send the physical link utilization data for the LAG to the controller. A variety of computational techniques may be used to determine which physical link is least utilized and how new or existing data flows can be steered to the underutilized physical link. Note that this analysis may be performed on data (such as the one or more determined communication performance metrics) that is collected over a period of time. The controller, which may, for example, be a cloud-based controller, may then instruct the computer network device(s) to select a physical link in the LAG for a given type of traffic (such as VoIP, video, etc.), because different types of traffic have different characteristics, such as different latency (e.g., VoIP may only allow a delay of 70 ms), bandwidth, jitter, etc. Computer network devices may store the assignments and may apply them to existing or new data flows in a network.

The communication technique may help ensure that, when access points are connected to switches or router via a LAG connection, that their Wi-Fi throughput and quality-of-service experience (QoE) is not degraded by improving the usage of the capacity or capabilities of the physical links in the LAG (such as the percentage of the capacity that is used). For example, the communication technique may help ensure that Wi-Fi throughput is not throttled during peak hours of usage because of incorrect assignment of data flows to the physical links in a LAG. Notably, the communication technique may reduce or eliminate instances where a physical link in a LAG is underutilized.

As discussed previously, the IEEE 802.1ax-2008 standard defines a LAG with individual ports that have the same speed or data rate. Consequently, it may not be possible to bundle physical links that have different speeds into a LAG. Moreover, typically, a data flow may be selected or assigned to a physical link in a LAG using a hash function or table and one or more input parameters (such as source or destination locations). However, the hash table may not identify the correct physical link in the LAG because it may not consider the capabilities of different physical media in a heterogeneous LAG and/or the needs of different types of traffic coming into a network.

When the physical links in the LAG operate at different speeds and/or have different underlying physical media types (e.g., copper wire, optical fiber, microwave, and/or satellite link), the communication technique may be used to improve the assignments of data flows to the physical links. Notably, computer network devices may determine the utilization (and, more generally, one or more communication performance metrics) of each of the physical links in the LAG. Note that utilization may be determined based at least in part on: a number of data flows each physical link is carrying, a number of bytes, a type of traffic, etc. Then, using the determined utilization, a local and/or a remote controller may assign a data flow to one of the physical links.

In some embodiments, a cloud-based controller may receive information specifying the determined communication performance metrics from computer network devices in a network. This may allow the controller to map the entire network, including all the hops in the physical links. Using this information, the controller may globally determine assignments of data flows to physical links between the computer network devices in the network. This capability may allow the controller to determine which physical links can best serve the needs of different data flows and/or types of traffic (such as bandwidth, jitter, latency, etc.). The controller may provide the assignments to the computer network devices, so that current or future data flows can be appropriately steered in order to meet end-to-end service-level agreements in the network (as opposed to meeting the local requirements of two adjacent computer network devices).

In some embodiments, the controller may replicate the data flows in a LAG on another link to facilitate surveillance (e.g., based at least in part on a court order) or in order to debug a feature or a performance issue. Moreover, the controller may allow dormant physical links in a LAG to be dynamically activated. For example, the controller may instruct individual computer network devices to dynamically activate one or more dormant physical links in order to boost capacity in the LAG. In these embodiments, neighboring computer network devices may indicate or advise each other about a new physical link in a LAG that has become active. Furthermore, when a computer network device activates a physical link in a LAG, it may send an upstream message to the cloud-based controller indicating that the new physical link has been activated. This information may allow the cloud-based controller to update its network map with the latest view of the network and LAG components.

We now describe embodiments of an electronic device, which may perform at least some of the operations in the communication technique. FIG. 7 presents a block diagram illustrating an example of an electronic device 700 in accordance with some embodiments, such as one of computer network devices 108, one of access points 110, one of electronic devices 112 or one of controllers 124. This electronic device includes processing subsystem 710, memory subsystem 712, and networking subsystem 714. Processing subsystem 710 includes one or more devices configured to perform computational operations. For example, processing subsystem 710 can include one or more microprocessors, ASICs, microcontrollers, programmable-logic devices, one or more graphics process units (GPUs) and/or one or more digital signal processors (DSPs).

Memory subsystem 712 includes one or more devices for storing data and/or instructions for processing subsystem 710 and networking subsystem 714. For example, memory subsystem 712 can include dynamic random access memory (DRAM), static random access memory (SRAM), and/or other types of memory. In some embodiments, instructions for processing subsystem 710 in memory subsystem 712 include: one or more program modules or sets of instructions (such as program instructions 722 or operating system 724), which may be executed by processing subsystem 710. Note that the one or more computer programs may constitute a computer-program mechanism. Moreover, instructions in the various modules in memory subsystem 712 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 710.

In addition, memory subsystem 712 can include mechanisms for controlling access to the memory. In some embodiments, memory subsystem 712 includes a memory hierarchy that comprises one or more caches coupled to a memory in electronic device 700. In some of these embodiments, one or more of the caches is located in processing subsystem 710.

In some embodiments, memory subsystem 712 is coupled to one or more high-capacity mass-storage devices (not shown). For example, memory subsystem 712 can be coupled to a magnetic or optical drive, a solid-state drive, or another type of mass-storage device. In these embodiments, memory subsystem 712 can be used by electronic device 700 as fast-access storage for often-used data, while the mass-storage device is used to store less frequently used data.

Networking subsystem 714 includes one or more devices configured to couple to and communicate on a wired and/or wireless network (i.e., to perform network operations), including: control logic 716, an interface circuit 718 and one or more antennas 720 (or antenna elements). (While FIG. 7 includes one or more antennas 720, in some embodiments electronic device 700 includes one or more nodes, such as nodes 708, e.g., a network node that can be coupled or connected to a network or link, or an antenna node, connector or a pad that can be coupled to the one or more antennas 720. Thus, electronic device 700 may or may not include the one or more antennas 720.) For example, networking subsystem 714 can include a Bluetooth networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), a satellite communication system, an Ethernet networking system, a cable modem networking system, and/or another networking system.

Note that a transmit or receive antenna pattern (or antenna radiation pattern) of electronic device 700 may be adapted or changed using pattern shapers (such as reflectors) in one or more antennas 720 (or antenna elements), which can be independently and selectively electrically coupled to ground to steer the transmit antenna pattern in different directions. Thus, if one or more antennas 720 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 700 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 714 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 700 may use the mechanisms in networking subsystem 714 for performing simple wireless communication between the electronic devices, e.g., transmitting advertising or beacon frames and/or scanning for advertising frames transmitted by other electronic devices as described previously.

Within electronic device 700, processing subsystem 710, memory subsystem 712, and networking subsystem 714 are coupled together using bus 728. Bus 728 may include an electrical, optical, and/or electro-optical connection that the subsystems can use to communicate commands and data among one another. Although only one bus 728 is shown for clarity, different embodiments can include a different number or configuration of electrical, optical, and/or electro-optical connections among the subsystems.

In some embodiments, electronic device 700 includes a display subsystem 726 for displaying information on a display, which may include a display driver and the display, such as a liquid-crystal display, a multi-touch touchscreen, etc.

Electronic device 700 can be (or can be included in) any electronic device with at least one network interface. For example, electronic device 700 can be (or can be included in): a desktop computer, a laptop computer, a subnotebook/netbook, a server, a tablet computer, a smartphone, a cellular telephone, a smartwatch, a consumer-electronic device, a portable computing device, an access point, a transceiver, a router, a switch, communication equipment, a computer network device, a stack of computer network devices, an access point, a controller, test equipment, and/or another electronic device.

Although specific components are used to describe electronic device 700, in alternative embodiments, different components and/or subsystems may be present in electronic device 700. For example, electronic device 700 may include one or more additional processing subsystems, memory subsystems, networking subsystems, and/or display subsystems. Additionally, one or more of the subsystems may not be present in electronic device 700. Moreover, in some embodiments, electronic device 700 may include one or more additional subsystems that are not shown in FIG. 7. Also, although separate subsystems are shown in FIG. 7, in some embodiments some or all of a given subsystem or component can be integrated into one or more of the other subsystems or component(s) in electronic device 700. For example, in some embodiments program instructions 722 are included in operating system 724 and/or control logic 716 is included in interface circuit 718. In some embodiments, the communication technique is implemented using information in layer 2 and/or layer 3 of the Open Systems Interconnection (OSI) model.

Moreover, the circuits and components in electronic device 700 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 714 (or, more generally, of electronic device 700). The integrated circuit may include hardware and/or software mechanisms that are used for transmitting wired and/or wireless signals from electronic device 700 and receiving signals at electronic device 700 from other electronic devices. Aside from the mechanisms herein described, radios are generally known in the art and hence are not described in detail. In general, networking subsystem 714 and/or the integrated circuit can include any number of radios. Note that the radios in multiple-radio embodiments function in a similar way to the described single-radio embodiments.

In some embodiments, networking subsystem 714 and/or the integrated circuit include a configuration mechanism (such as one or more hardware and/or software mechanisms) that configures the network interface(s) or radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Ethernet and a Wi-Fi communication protocol as an illustrative example, in other embodiments a wide variety of communication protocols and, more generally, wired and/or wireless communication techniques may be used. Thus, the communication technique may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication technique may be implemented using program instructions 722, operating system 724 (such as a driver for interface circuit 718) or in firmware in interface circuit 718. Alternatively or additionally, at least some of the operations in the communication technique may be implemented in a physical layer, such as hardware in interface circuit 718.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the communication technique, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
ports;
a data plane, coupled to the ports, configured to direct packets or frames in a network based at least in part on destinations of the packets or frames, wherein the ports are associated with physical links that use communication protocols;
a control plane coupled to the data plane, configured to:
determine one or more first communication performance metrics of a first port in a first physical link in a link aggregation group (LAG) and one or more second communication performance metrics of a second port in a second physical link in the LAG; and
assign, based at least in part on the determined one or more first communication performance metrics and the determined one or more second communication performance metrics, a given packet or a given frame to the first port or the second port in the LAG.

2. The electronic device of claim 1, wherein the computer network device comprises a switch or a router.

3. The electronic device of claim 1, wherein the network comprises: a wired network, a wireless network or a satellite network.

4. The electronic device of claim 1, wherein the control plane is configured to define at least the first port in the first physical link and the second port in the second physical link as being part of the LAG.

5. The electronic device of claim 1, wherein the first physical link and the second physical link use different types of media, different communication protocols or both.

6. The electronic device of claim 5, wherein the different communication protocols have one or more of: different data rates or speeds, different throughputs, or different capacities.

7. The electronic device of claim 5, wherein the first physical link and the second physical link use the same medium and the same communication protocol.

8. The electronic device of claim 1, wherein the given packet or the given frame is assigned to a first port or a second port in the LAG based at least in part on a type of traffic of a data flow that comprises the given packet or the given frame.

9. The electronic device of claim 1, wherein the given packet or the given frame is assigned to a first port or the second port in the LAG based at least in part on a priority associated with a type of traffic of a data flow.

10. The electronic device of claim 1, wherein a given communication performance metric comprises utilization or throughput.

11. The electronic device of claim 1, wherein the assignment provides a more balanced utilization of the first physical link and the second physical link in the LAG than a technique in which the first physical link or the second physical link is randomly or pseudo-randomly selected.

12. The electronic device of claim 1, wherein determining the assignment comprises:
providing, addressed to a separate controller, information specifying the one or more determined first communication performance metrics and the one or more determined second communication performance metrics; and
receiving, associated with the separate controller, information specifying the assignment.

13. The electronic device of claim 1, wherein the assignment is based at least in part on capabilities of the first physical link and the second physical link in the LAG.

14. The electronic device of claim 1, wherein the assignment assigns different data flows to the first physical link or the second physical link.

15. The electronic device of claim 1, wherein the first physical link or the second physical link is a dormant physical link until the assignment of the given packet or the given frame to the dormant physical link.

16. A non-transitory computer-readable storage medium for use in conjunction with computer network device, the computer-readable storage medium storing program instructions that, when executed by the computer network device, cause the computer network device to perform operations comprising:
determining one or more first communication performance metrics of a first port in a first physical link in a link aggregation group (LAG) and one or more second communication performance metrics of a second port in a second physical link in the LAG; and
assigning, based at least in part on the determined one or more first communication performance metrics and the determined one or more second communication performance metrics, a given packet or a given frame to the first port or the second port in the LAG.

17. The non-transitory computer-readable storage medium of claim 16, wherein the first physical link and the second physical link use different types of media, different communication protocols or both.

18. The non-transitory computer-readable storage medium of claim 16, wherein the given packet or the given frame is assigned to a first port or a second port in the LAG based at least in part on a type of traffic of a data flow that comprises the given packet or the given frame.

19. The non-transitory computer-readable storage medium of claim 16, wherein determining the assignment comprises:
providing, addressed to a separate controller, information specifying the one or more determined first communication performance metrics and the one or more determined second communication performance metrics; and
receiving, associated with the separate controller, information specifying the assignment.

20. A method for load balancing physical links in a link aggregation group (LAG) comprising:
by a computer network device:
determining one or more first communication performance metrics of a first port in a first physical link in the LAG and one or more second communication performance metrics of a second port in a second physical link in the LAG; and
assigning, based at least in part on the determined one or more first communication performance metrics and the determined one or more second communication performance metrics, a given packet or a given frame to the first port or the second port in the LAG.
